(19) United States
(12) Patent Application Publication
(10) Pub. No.: US 2012/0140856 A1
(43) Pub. Date: Jun. 7, 2012

(54) RECEIVING APPARATUS AND RECEIVING METHOD

(75) Inventors: Mitsumasa Yoshikawa, Yokohama (JP); Keitaro Otsuka, Yokohama (JP)

(73) Assignee: FUJITSU SEMICONDUCTOR LIMITED, Yokohama-shi (JP)

(21) Appl. No.: 13/241,774

(22) Filed: Sep. 23, 2011

(30) Foreign Application Priority Data
Dec. 2, 2010 (JP) 2010-269041

(51) Int. Cl. H04L 27/00

(52) U.S. Cl. 375/316

(57) ABSTRACT

A receiving apparatus for being viewable of a first broadcast based on a first received signal received using a first frequency band as any one frequency band of a plurality of frequency bands, or being viewable of a second broadcast based on a second received signal received using a second frequency band as all frequency bands other than the first frequency band of the plurality of frequency bands, the receiving apparatus including: a receiving unit which receives a third received signal by using a third frequency band as any one frequency band of a plurality of frequency bands included in the second frequency band when the first broadcast is being viewed; and a control unit which determines whether the second broadcast is viewable or nor based on the third received signal, and switches from viewing of the first broadcast to viewing of the second broadcast.

### CROSS-REFERENCE TO RELATED APPLICATION

This application is based upon and claims the benefit of priority of the prior Japanese Patent Application No. 2010-269041, filed on Dec. 2, 2010, the entire contents of which are incorporated herein by reference.

### FIELD

The embodiments discussed herein are related to a receiving apparatus and a receiving method.

### BACKGROUND

Nowadays, in terrestrial digital broadcast, one-channel worth of frequency bandwidth (for instance, 6 MHz) is divided into 13 segments, and 12 segments (hereinafter referred to as the “full segment”) of 13 segments are used for broadcasting to fixed receivers. Moreover the remaining 1 segment (hereinafter referred to as the “one segment”) is used for broadcasting to mobile receivers such as mobile phones.

FIG. 15A is a diagram illustrating an example of the divided segments. The number in the square of FIG. 15A depicts the segment number. For example, a broadcasting station or the like uses segment numbers “1” to “12” to perform full segment broadcast (high quality broadcast), and uses segment number “0” to perform one segment broadcast (low quality broadcast).

As a receiving apparatus that receives wireless signals that were transmitted as the foregoing terrestrial digital broadcast, for example, there is a car navigation system. A receiving apparatus such as a car navigation system can switch between full segment broadcast viewing and one segment broadcast viewing, for example, according to the radio wave condition.

FIG. 15B is a diagram illustrating a configuration example of this kind of receiving apparatus 200. An antenna 201 receives the wireless signals that were transmitted from a broadcasting station or the like, and an RF unit 202, for example, amplifies the received wireless signals and converts them into low frequency received signals. An OFDM demodulation unit 203 performs analog/digital conversion, FFT (Fast Fourier Transform) and the like to the converted received signals and outputs the modulated signals of the respective carriers (carrier waves). A layer separation unit 204 separates the modulated signals into layer A and layer B based on a TMCC (Transmission and Multiplexing Configuration Control) signal contained in the modulated signals, and outputs the modulated signals of layer A to a first error correction unit 205, and outputs the modulated signals of layer B to a second error correction unit 206. The first and second error correction units 205, 206 perform, to the modulated signals of the respective layers, demodulation processing such as waveform equalization processing and demapping processing, and additionally perform decoding processing such as de-interleave processing and error correction processing. The output thereof is supplied, for example, to a subsequent-stage processing circuit.

Note that, in terrestrial digital broadcast, broadcasting stations and the like can use different modulation methods for sending the respective segments, and the aggregate of the respective segments is referred to as, for example, a layer. For example, layer A is used as a segment for the “one segment” and layer B is used as a segment for the “full segment”. For example, the layer A-side modulation method is “QPSK (Quadrature Phase Shift Keying),” and the layer B-side modulation method is “64 QAM (Quadrature Amplitude Modulation).”

As an index for confirming the radio wave condition in this kind of receiving apparatus 200, for example, there are MER (Modulation Error Ratio) and BER (Bit Error Rate). The receiving apparatus 200 confirms the radio wave condition by comparing MER or BER with a threshold, and is thereby able to determine whether the full segment is viewable.

Here, MER is also referred to as, for example, modulation error ratio, and represents an error concerning the constellation of the received signal relative to the transmitted signal. Thus, with the receiving apparatus 200, measurement of MER is performed in the first and second error correction units 205, 206 where decoding processing is performed.

Moreover, BER is also referred to as, for example, bit error ratio, and represents the ratio of the number of received bits relative to the number of error bits. Thus, with the receiving apparatus 200, measurement of BER is performed in the first and second error correction units 205, 206 where decoding processing is performed.

FIG. 16 and FIG. 17 are flowcharts respectively illustrating an operational example of switching control in the receiving apparatus 200 using the foregoing MER or BER. Among the above, FIG. 16 illustrates an operational example of a case of switching from one segment viewing to full segment viewing, and FIG. 17 illustrates an operational example of a case of switching from full segment viewing to one segment viewing.

When switching from one segment viewing to full segment viewing is performed, the receiving apparatus 200 activates the layer A-side first error correction unit 205, and, for example, causes the first error correction unit 205 to perform decoding processing to the received signals of the one segment broadcast. The receiving apparatus 200 thereby becomes a status of one segment viewing, and a user can thereby view the one segment broadcast (S101).

Subsequently, the receiving apparatus 200 determines whether to confirm the full segment status (S102). For example, the receiving apparatus 200 determines whether to confirm the full segment status based on whether a given period of time is lapsed.

Subsequently, the receiving apparatus 200 proceeds to S101 if the full segment status is not to be confirmed, and waits until it is time to confirm the full segment status (for instance, waits until a given period of time is lapsed) (loop of No in S102 and S101). Meanwhile, when the receiving apparatus 200 is to confirm the full segment status (for instance, when a given period of time is lapsed) (Yes in S102), it activates the second error correction unit 206 in order to confirm the radio wave condition on the full segment side (S103). Based on this activation, the second error correction unit 206 can measure the full segment-side MER or BER (S104).

The receiving apparatus 200 whether the full segment is viewable by, for example, comparing the measured MER or BER with the threshold that enables full segment viewing (S105).

When the receiving apparatus 200 determines that the full segment is viewable (Yes in S105), it enables full segment viewing (S106). For example, the receiving apparatus 200 stops the activation of the first error correction unit 205 when the MER or BER is not less than the threshold that enables full segment viewing. The second error correction unit 206 that is activated for measuring the MER or BER performs decoding processing and the like to the received signals of the full segment broadcast. Consequently, switching from one segment viewing to full segment viewing is performed in the receiving apparatus 200, and the user is thereby able to view the full segment broadcast.

Meanwhile, when the receiving apparatus 200 determines that the full segment is not viewable (No in S105), it changes to the status of one segment viewing (S101). For example, the receiving apparatus 200 determines that the full segment is not viewable when the measured MER or BER is smaller than the threshold that enables full segment viewing, and stops the layer B-side second error correction unit 206, and changes to the status of one segment viewing.

FIG. 17 is a flowchart illustrating an operational example of a case of contrarily switching from full segment viewing to one segment viewing. The receiving apparatus 200 enters a status of full segment viewing by activating the layer B-side second error correction unit 206 (S111). The receiving apparatus 200 causes the second error correction unit 206 to measure the MER or BER in order to confirm the received radio wave condition on the full segment side (S112). The receiving apparatus 200 maintains the status of full segment viewing (5111), for example, when the MER or BER measured by the second error correction unit 206 is not less than the threshold that enables full segment viewing (Yes in S113).

Meanwhile, the receiving apparatus 200 stops the layer B-side second error correction unit 206, for example, when the measured MER or BER is smaller than the threshold that enables full segment viewing (No in S113), and activates the layer A-side first error correction unit 205 and changes to the status of one segment viewing (S114).

As another example of this kind of receiving apparatus, for example, there is an information processing apparatus which is provided, in parallel, with a broadcast receiving function and a telephone function which switches the 13 segment broadcast reception to the 1 segment broadcast reception upon receiving an incoming call from the base station while broadcast signals are being received.

Moreover, as another example of the receiving apparatus, there is an OFDM receiving apparatus which switches to receiving the 1 segment broadcast when a Doppler shift value detected from a post-FFT received OFDM signal becomes a certain value or higher during the reception of the 12 segment broadcast.

Patent Document 1: Japanese Laid-open Patent Publication No. 2005-109828

Patent Document 2: Japanese Laid-open Patent Publication No. 2009-284383

Here, attention is given to the layer A-side first error correction unit 205 and the layer B-side second error correction unit 206 when switching is performed from one segment viewing to full segment viewing in the receiving apparatus 200. When the user is engaged in one segment viewing (for instance, S101 in FIG. 16), the receiving apparatus 200 is in the “layer A only” status. The “layer A only” status is, for example, the status where, upon layer separation being performed by the layer separation unit 204, the first error correction unit 205 is operated and the second error correction unit 206 is not operated.

Moreover, when the user is engaged in full segment viewing (for instance, S106), the receiving apparatus 200 is in the “layer B only” status. The “layer B only” status is, for example, the status where, upon layer separation being performed, the second error correction unit 206 is operated and the first error correction unit 205 is not operated.

In addition, when the radio wave condition of the full segment is confirmed during one segment viewing, the receiving apparatus 200 is in the “both layers A and B” status (for instance, S103). The “both layers A and B” status is, for example, the status where both the first and second error correction units 105, 106 are operated.

When the radio wave condition is favorable in this kind of receiving apparatus 200, for example, the MER or BER becomes greater than the threshold that enables full segment viewing, and switching to full segment viewing (for instance, S106) is performed with a single determination (for instance, Yes in S105).

Nevertheless, when the radio wave condition is not favorable, for example, the MER or BER falls below the threshold that enables full segment viewing (for instance, No in S105), and the receiving apparatus 200 changes to the “layer A only” status (S101). Thus, in the subsequent processing, the receiving apparatus 200 once again changes to the “both layers A and B” status. Accordingly, when the radio wave condition is not favorable, the number of times that the receiving apparatus 200 changes to the “both layers A and B” status will become a plurality of times, and more power is consumed by the receiving apparatus 200 in comparison to the case where the number of times of changing to the “both layers A and B” status is once.

Moreover, both the information processing apparatus provided with a broadcast receiving function and a telephone function and the OFDM receiving apparatus described above switch from either “12 segments” or “13 segments” to “1 segment”. Neither the information processing apparatus nor the OFDM receiving apparatus switch to the full segment viewing when one segment viewing is being performed, and neither are able to reduce the power consumption regardless of the radio wave condition.

### SUMMARY

According to an aspect of the invention, a receiving apparatus for being viewable of a first broadcast based on a first received signal received using a first frequency band as any one frequency band of a plurality of frequency bands, or being viewable of a second broadcast based on a second received signal received using a second frequency band as all frequency bands other than the first frequency band of the plurality of frequency bands, the receiving apparatus including: a receiving unit which receives a third received signal by using a third frequency band as any one frequency band of a plurality of frequency bands included in the second frequency band when the first broadcast is being viewed; and a control unit which determines whether the second broadcast is viewable or nor based on the third received signal, and switches from viewing of the first broadcast to viewing of the second broadcast when it is determined that the second broadcast is viewable.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a configuration example of the receiving apparatus;

FIG. 2 is a diagram illustrating a configuration example of the transmitting/receiving system;

FIG. 3 is a diagram illustrating a configuration example of the receiving apparatus;

FIG. 4 is a diagram illustrating a configuration example of the OFDM demodulation unit;

FIG. 5 is a diagram illustrating a configuration example of the 1 segment unit correlation detection unit;

FIG. 6 is a diagram illustrating a configuration example of the first (or second) 1 segment unit correlator;

FIG. 7 is a diagram illustrating a configuration example of the peak detection unit;

FIG. 8 is a flowchart illustrating an example of the switching operation from one segment viewing to full segment viewing;

FIG. 9 is a flowchart illustrating an example of the switching operation from full segment viewing to one segment viewing;

FIG. 10 is a diagram illustrating an example of the segment pattern;

FIG. 11A and FIG. 11B are diagrams respectively illustrating an example of the segment pattern;

FIG. 12 is a diagram illustrating an example of the segment pattern;

FIG. 13 is a diagram illustrating an example of the segment pattern;

FIG. 14 is a diagram illustrating an example of the segment pattern;

FIG. 15A is diagram illustrating an example of the divided segments, and FIG. 15B is a diagram illustrating a configuration example of the receiving apparatus, respectively;

FIG. 16 is a flowchart illustrating an example of the switching operation from one segment viewing to full segment viewing;

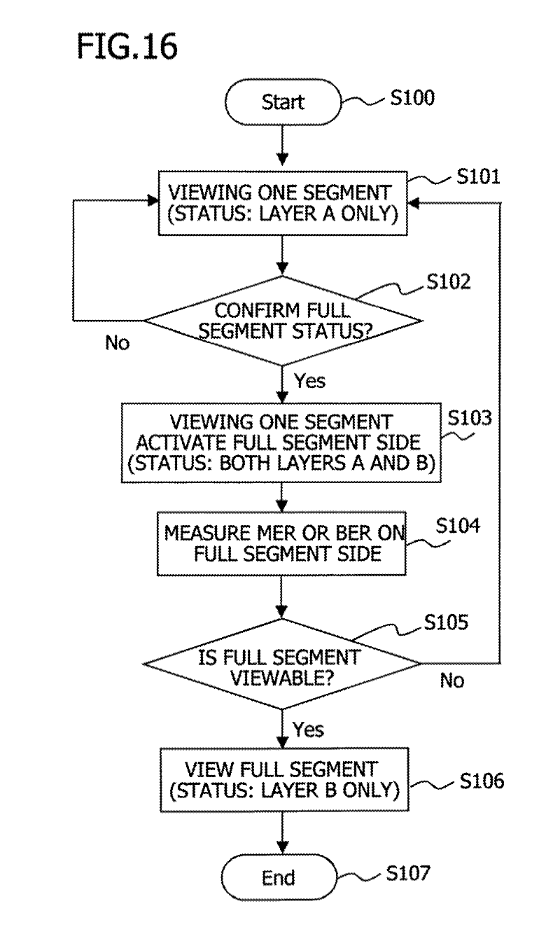

FIG. 17 is a flowchart illustrating an example of the switching operation from full segment viewing to one segment viewing; and

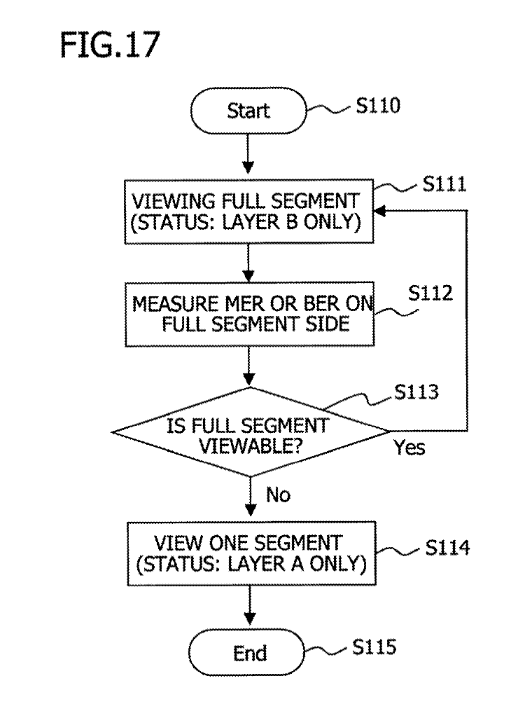

FIG. 18 is a diagram illustrating another configuration example of the receiving apparatus.

### DESCRIPTION OF EMBODIMENTS

Embodiments for implementing the present invention are now explained.

### First Embodiment

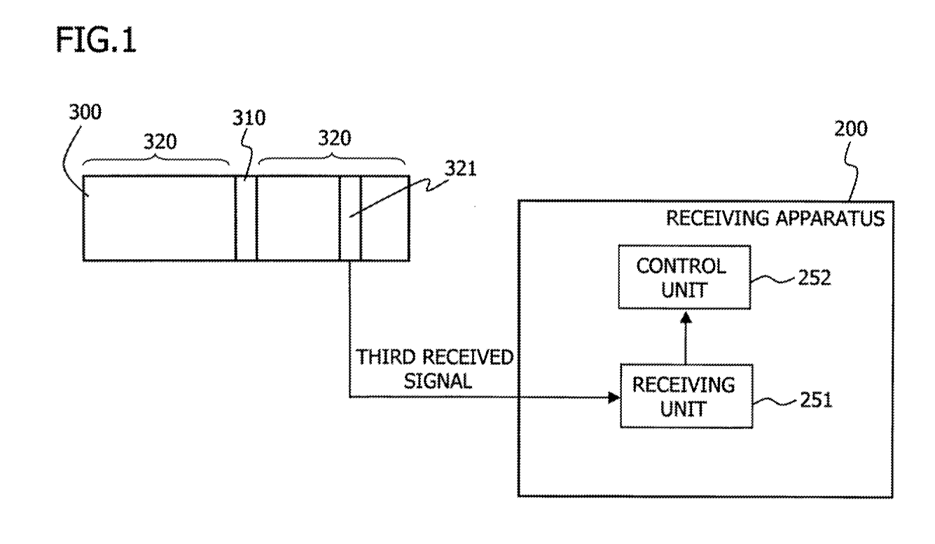

The first embodiment is foremost explained. FIG. 1 is a diagram illustrating a configuration example of a receiving apparatus 200 in the first embodiment.

The receiving apparatus 200 enables the viewing of a first broadcast based on a first received signal received using a first frequency band 310 which represents any one frequency band of a plurality of frequency bands 300. Moreover, the receiving apparatus 200 enables the viewing of a second broadcast based on a second received signal received using a second frequency band 320 which represents all frequency bands other than the first frequency band 310 of the plurality of frequency bands 300. The plurality of frequency bands 300 are, for example, frequency bands for terrestrial digital broadcast. The respective frequency bands of the plurality of frequency bands 300 is also referred to as, for example, segment. The receiving apparatus 200 enables the viewing of the first broadcast and also enables the viewing of the second broadcast.

The receiving apparatus 200 includes a receiving unit 251 and a control unit 252.

The receiving unit 251 receives a third received signal by using a third frequency band 321 which represents any one frequency band of a plurality of frequency bands included in the second frequency band 320 when the first broadcast is being viewed.

The control unit 252 determines whether the second broadcast is viewable or not based on the third received signal, and switches from viewing of the first broadcast to viewing of the second broadcast when it is determined that the second broadcast is viewable.

Thus, the receiving apparatus 200, when the first broadcast is being viewed, determines whether the second broadcast is viewable based on the third received signal received using the third frequency band 321. Accordingly, for example, the number of frequency bands that are used by the receiving apparatus 200 for determining the viewability is also fewer than the case of measuring the MER or BER by receiving the received signals through the use of all of the plurality of frequency bands 300 or second frequency bands 320. Moreover, the receiving apparatus 200 does not operate the error correction units of the two layers a plurality of times in order to measure the MER or BER when the radio wave condition is not favorable. Thus, in comparison to the foregoing case, the receiving apparatus 200 can reduce its power consumption regardless of the radio wave condition. In addition, since the receiving apparatus 200 determines whether the second broadcast is viewable when the first broadcast is being viewed, it can continuously perform view switching without any interruption in the switching from first broadcast viewing to second broadcast viewing.

### Second Embodiment

<Example of Overall Configuration>

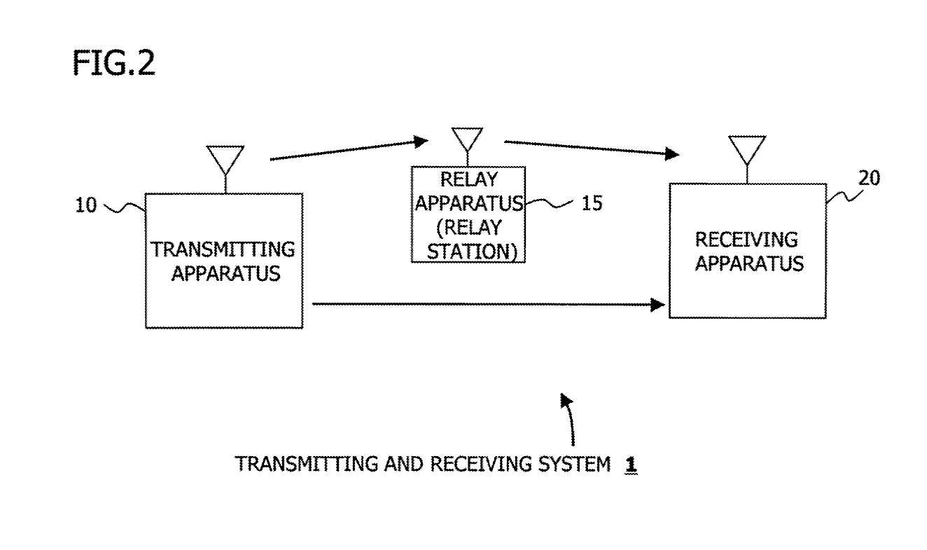

The second embodiment is now explained. FIG. 2 is a diagram illustrating a configuration example of a transmitting/receiving system 1. The transmitting and receiving system 1 is also, for example, a terrestrial digital broadcast system. The transmitting and receiving system 1 includes a transmitting apparatus 10 and a relay apparatus (or relay station) 15, and a receiving apparatus 20.

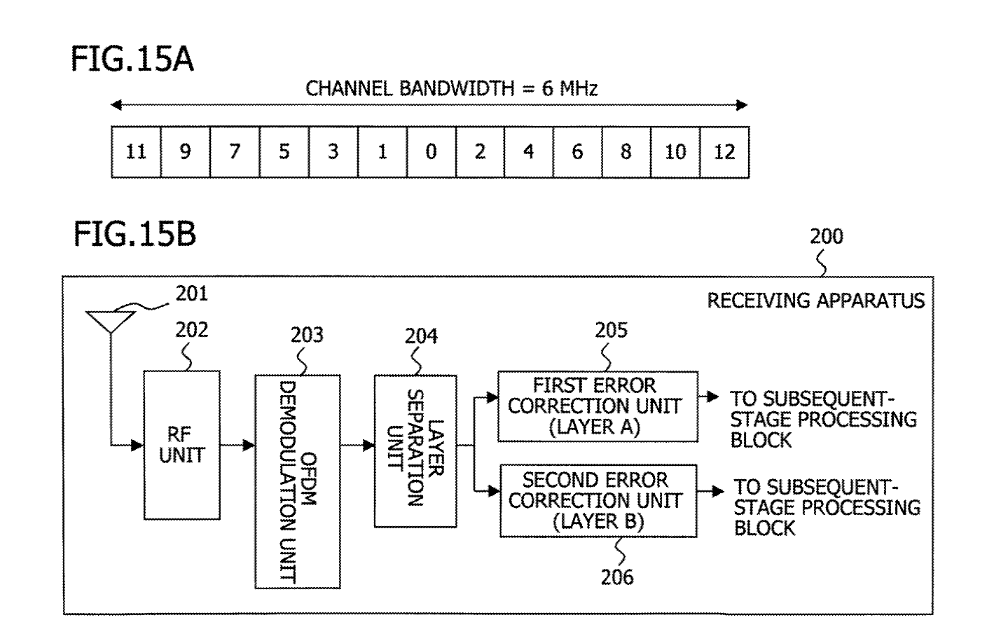

The transmitting apparatus 10 is, for example, a broadcasting station that performs terrestrial digital broadcast, and transmits wireless signals containing video data and audio data. The transmitting apparatus 10 divides, for example, one-channel worth of frequency bands into a plurality of frequency bands, and uses the divided frequency bands as needed to transmit the wireless signals (for instance, FIG. 15A described above). For example, during a “one segment broadcast”, the transmitting apparatus 10 uses the “0”th segment among the divided frequency bands to send the wireless signals, and, during a “full segment broadcast”, uses the “1”st to “12”th segments to send the wireless signals.

The relay apparatus 15 relays the wireless signals that were transmitted from the transmitting apparatus 10, and, for example, amplifies the power of the received transmitted signals and transmits the same. Note that one or more relay apparatuses 15 may be provided.

The receiving apparatus 20 is, for example, a car navigation apparatus (or system), or a portable information terminal such as a mobile phone or PDA (Personal Digital Assistance). The receiving apparatus 20 can receive the wireless signals that were transmitted from the transmitting apparatus 10 via the relay apparatus 15, or directly from the transmitting apparatus 10 without going through the relay apparatus 15. In the second embodiment, the receiving apparatus 20 can switch between the viewing of the “one segment broadcast” and the viewing of the “full segment broadcast”, and the user can view the “one segment broadcast” or the “full segment broadcast” based on the foregoing switching. The receiving apparatus 20 can enable the viewing of the “one segment broadcast” based on the wireless signals that have been received using the frequency band with the segment number “0” and enable the viewing of the “full segment broadcast” based on the wireless signals that have been received using the frequency band with the segment numbers “1” to “12”.

<Configuration Example of Receiving Apparatus 20>

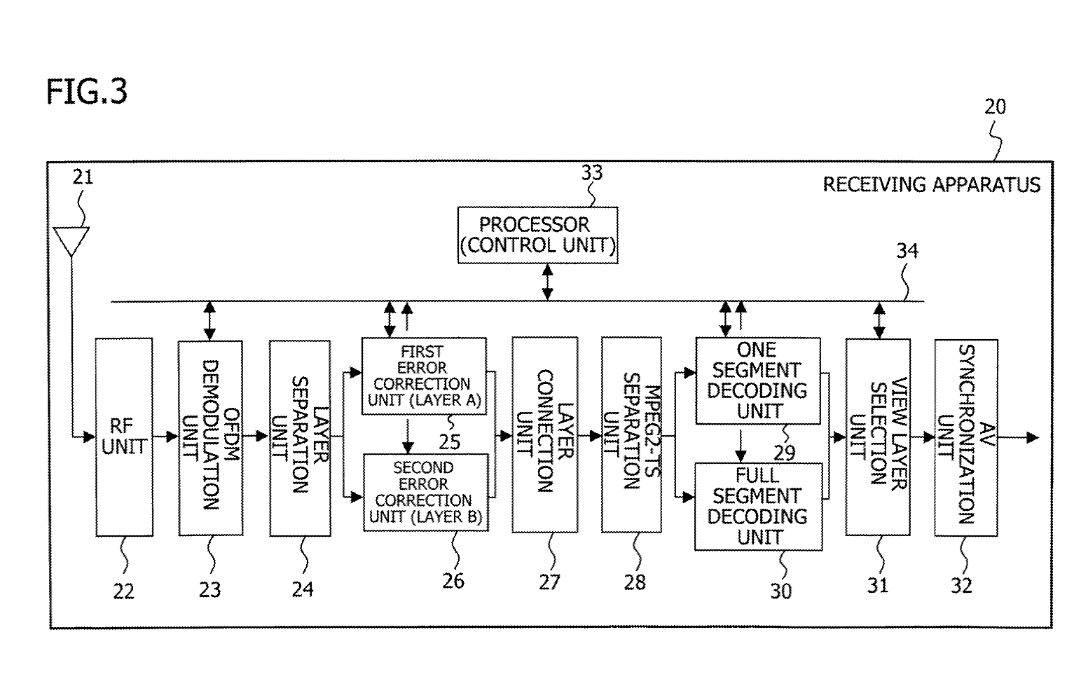

The configuration example of the receiving apparatus 20 is now explained. FIG. 3 is a diagram illustrating a configuration example of the receiving apparatus 20. The receiving apparatus 20 includes an antenna 21, an RF (Radio Frequency) unit 22, an OFDM (Orthogonal Frequency Division Multiplexing) demodulation unit 23, a layer separation unit 24, first and second error correction units 25, 26, a layer connection unit 27, an MPEG-2TS separation unit 28, a one segment decoding unit 29, a full segment decoding unit 30, a view layer selection unit 31, an AV synchronization unit 32, and a processor 33. Note that the processor 33 is connected, via an internal bus 34, to the OFDM demodulation unit 23, the first and second error correction units 25, 26, the one segment decoding unit 29, the full segment decoding unit 30, and the view layer selection unit 31.

Note that the receiving unit 251 in the first embodiment corresponds to, for example, the antenna 21, the RF unit 22, the OFDM demodulation unit 23, the layer separation unit 24, the first and second error correction units 25, 26, the layer connection unit 27, the MPEG-2TS separation unit 28, the one segment decoding unit 29, the full segment decoding unit 30, the view layer selection unit 31, and the AV synchronization unit 32. Moreover, the control unit 252 in the first embodiment corresponds to, for example, the processor 33.

The antenna 21 receives the wireless signals that were transmitted from the relay apparatus 15 or the transmitting apparatus 10, and outputs the same to the RF unit 22. Note that a plurality of antennae may be provided for diversity communication or the like.

The RF unit 22 frequency-converts (or down-converts) the received wireless signal into baseband signals of the base bandwidth, and outputs the same. The RF unit 22 includes, for example, a frequency converter, a band-pass filter, an amplification circuit and the like for performing the foregoing frequency conversion.

The OFDM demodulation unit 23 converts baseband signals into digital signals, and additionally converts time domain signals into frequency domain signals in order to extract the modulation signals that have been subjected to quadrature modulation by the respective carries. Thus, the OFDM demodulation unit 23 includes, for example, an analog to digital conversion unit, an FFT unit and the like. Details concerning the OFDM demodulation unit 23 will be described later. Moreover, the OFDM demodulation unit 23 includes a 1 segment unit correlation power detection unit. The 1 segment unit correlation power detection unit detects, for example, a peak correlation power value in segment units. The details thereof will also be described later. Note that the OFDM demodulation unit 23 is input with control signals from the processor 33 and, for example, performs FFT processing according to the FFT size contained in the control signals from the processor 33.

The layer separation unit 24 separates the modulated signals into the two signals of layer A (for one segment) and layer B (for full segment) based on the TMCC signals contained in the modulated signals. The TMCC signals contain information regarding the number of segments that were used for transmitting the wireless signals, and, for example, the layer separation unit 24 separates the modulated signals in the respective modulates signals of layer A and layer B based on the foregoing information regarding the number of segments. The layer separation unit 24 outputs the layer A modulated signals to the first error correction unit 25, and outputs the layer B modulated signals to the second error correction unit 26, respectively.

The first error correction unit 25 performs demodulation processing to the layer A modulated signals. The demodulation processing includes, for example, waveform equalization processing to the modulated signals including delays, and demapping processing of demapping the respective signals with a certain signal length or longer. Based on the demodulation processing, it is possible to obtain digital signals prior to the modulation (for instance, QPSK) in the transmitting apparatus 10. The first error correction unit 25 additionally performs decoding processing to the demodulated signals. The decoding processing includes, for example, de-interleave processing of exchanging the signal sequence in a certain order, and error correction processing. The error correction processing includes reed Solomon decoding processing and convolutional decoding processing. Based on the decoding processing, it is possible to obtain digital signals prior to encoding in the transmitting apparatus 10. The first error correction unit 25 outputs the modulated signals that were subjected to demodulation processing and decoding processing as, for example, layer A transport stream signals (hereinafter referred to as the “TS signals”).

The second error correction unit 26 performs, to the layer B modulated signals, demodulation processing and decoding processing as with the first error correction unit 25. Based on the demodulation processing, it is possible to obtain digital signals prior to modulation (for instance, 64 QAM) in the transmitting apparatus 10. The first error correction unit 25 outputs the modulated signals that were subjected to demodulation processing a decoding processing as, for example, layer B TS signals. Note that the first and second error correction units 25, 26 are controlled to be activated or stopped according to the control signals from the processor 33.

The layer connection unit 27 layer-connects the layer A TS signals and the layer B TS signals, and, for example, outputs this as the TS signals.

The MPEG-2TS separation unit 28 separates the TS signals to be decompressed (or decoded) from the TS signals containing video data and audio data that were compressed (or encoded) in a format such as MPEG-2, and outputs the same. The MPEG-2TS separation unit 28, for example, separates the TS signals into the respective TS signals of layer A and layer B, outputs the layer A TS signals to the one segment decoding unit 29, and outputs the layer B TS signals to the full segment decoding unit 30. This kind of layer separation may also be performed, for example, by supplying, from the layer separation unit 24, the TMCC information that is used in the layer separation performed by the layer separation unit 24, and performing the layer separation based on this TMCC information.

The one segment decoding unit 29 decodes, for example, the one segment (layer A) TS signals. For example, since video data is compressed in H264 and audio data is compressed in formats such as MPEG-2, the one segment decoding unit 29 outputs the decoded one segment video data or audio data based on the corresponding decompression method.

The full segment decoding unit 30 decodes, for example, the full segment (layer B) TS signals. The full segment TS signals also contain video data or audio data compressed in formats such as H264 and MPEG-2. The full segment decoding unit 30 outputs the decoded full segment video data or audio data based on the corresponding decompression method.

Note that the one segment decoding unit 29 and the full segment decoding unit 30 are also connected to the processor 33 via the internal bus 34, and, for example, are controlled to be activated or stopped according to the control signals from the processor 33.

The view layer selection unit 31 selects layer A or layer B, for example, according to the control signals from the processor 33, and outputs the decoded video data or audio data of layer A (for one segment) or the decoded video data or audio data of layer B (for full segment).

The AV synchronization unit 32 outputs the video data and audio data which were output from the view layer selection unit 31, for example, by synchronizing them with the reference time information which is transmitted from the transmitting apparatus 10. The video data and audio data output from the AV synchronization unit 32 are output to a monitor (not illustrated) or a speaker (not illustrated) as needed, and the user is thereby able to view the “one segment broadcast” or the “full segment broadcast”.

<Configuration Example of OFDM Demodulation Unit 23>

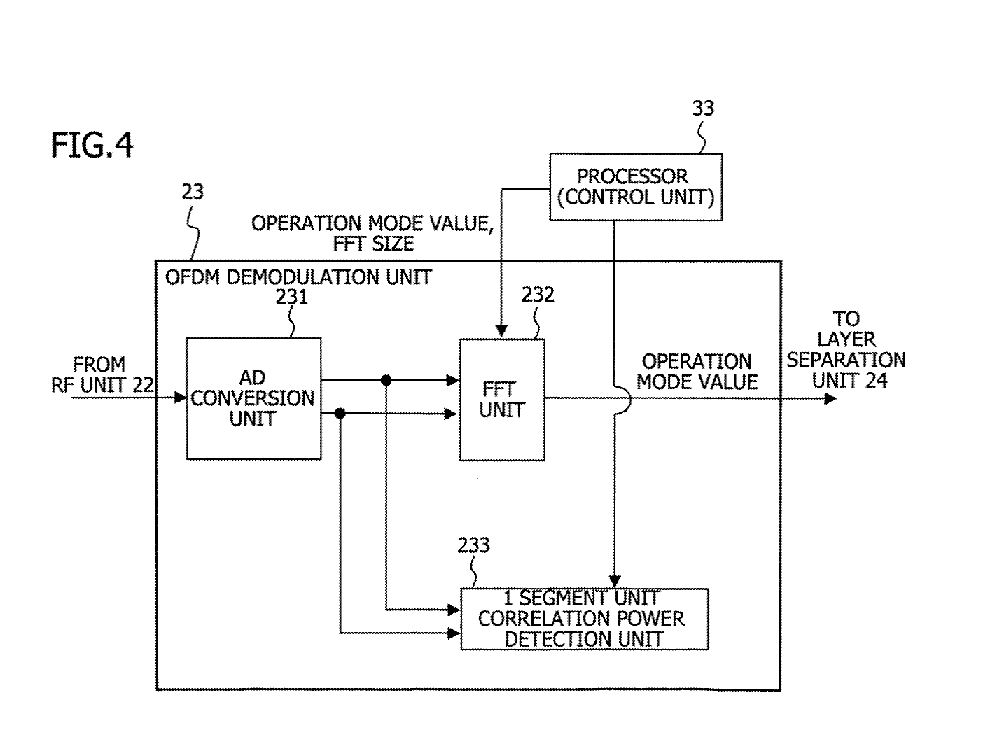

The configuration example of the OFDM demodulation unit 23 is now explained. FIG. 4 is a diagram illustrating a configuration example of the OFDM demodulation unit 23. The OFDM demodulation unit 23 includes an AD conversion unit 231, an FFT unit 232, and a 1 segment unit correlation power detection unit 233 (hereinafter referred to as the “correlation power detection unit”).

The AD conversion unit 231 converts the analog baseband signals that were output from the RF unit 22 into digital baseband signals. Based on this conversion, baseband signals (or OFDM signals), in which the I signals and Q signals are separated, can be extracted.

The FFT unit 232 converts the time domain signals into frequency domain signals by performing high-speed Fourier transformation to the baseband signals that were output from the AD conversion unit 231. The FFT unit 232 performs the high-speed Fourier transformation, for example, according to the FFT size contained in the control signals that were output from the processor 33. The FFT unit 232 can extract the modulated signals which were subjected to quadrature modulation by the respective carries based on the foregoing conversion into the frequency domain. The extracted modulated signals are output to the layer separation unit 24.

The correlation power detection unit 233 detects the peak correlation power value of the corresponding segments from the baseband signals that were separated into I signals and Q signals, for example, according to the operation mode value contained in the control signals that were output from the processor 33.

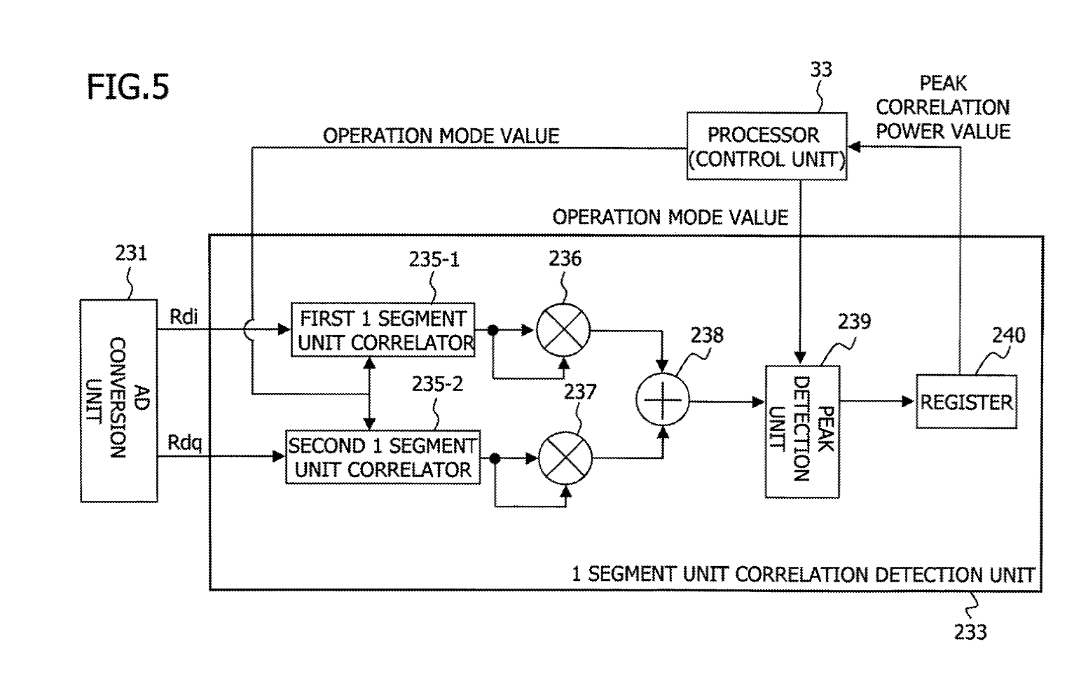

FIG. 5 is a diagram illustrating a configuration example of the correlation power detection unit 233. The correlation power detection unit 233 includes a first 1 segment unit correlator (hereinafter referred to as the “first correlator) 235-1, a second 1 segment unit correlator (hereinafter referred to as the “second correlator) 235-2, first and second multipliers 236, 237, a first adder 238, a peak detection unit 239, and a register 240.

The first correlator 235-1 detects the correlation power value of the corresponding segments according to the operation mode value from the in-phase component (or I signals) Rdi of the baseband signals (or received signals). The operation mode value represents, for example, a value that specifies one or more segments among the segments were divided into 13 segments (for instance, FIG. 15A). For example, when the operation mode value represents a segment with the segment number “0”, the first correlator 235-1 detects the correlation power value of the in-phase component of the received signals that were transmitted by using the segment with the segment number “0”. Moreover, for example, when the operation mode value represents the segment number “11” or “12”, the first correlator 235-1 detects the correlation power value of the in-phase component of the received signals that were transmitted by using the foregoing segments.

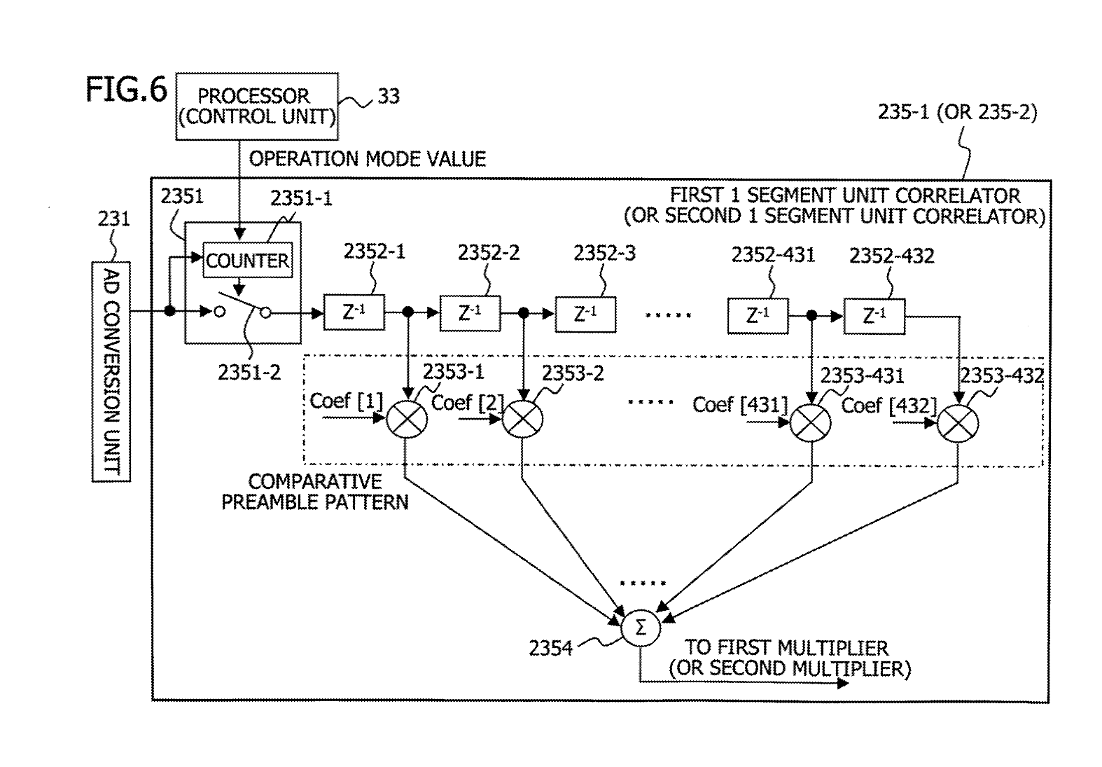

FIG. 6 is a diagram illustrating a configuration example of the first correlator 235-1. Note that, since the first correlator 235-1 and the second correlator 235-2 are configured the same, the first correlator 235-1 will be explained, and the explanation of the second correlator 235-2 is omitted.

The first correlator 235-1 includes a first switching control unit 2351, 1st to 432nd delay circuits (or shift registers) 2352-1 to 2352-432, 3rd to 434th multipliers 2353-1 to 2353-432, and a second adder 2354.

With the first switching control unit 2351, the switch is turned ON when the I signals of the segment corresponding to the operation mode value output from the processor 33 are input, and input I signals are output. Moreover, with the first switching control unit 2351, the switch is turned OFF when the I signals of a segment that does not correspond to the operation mode value is input, and the input I signals are not output.

In order to realize this kind of switching, for example, the first switching control unit 2351 is operated as follows. Specifically, the input order of the segments to be input to the receiving apparatus 20 is decided in advance; for example, from the segment (segment number “11” or the like) corresponding to a frequency band of a low frequency to the segment (segment number “12”) corresponding to a frequency band of a high frequency, or the opposite thereof. The first switching control unit 2351 counts, for example, the number of segments from the initially input segment, turns the switch ON when the segment number corresponding to the counted value coincides with the segment number that is specified as the operation mode value, and turns it OFF when they do not coincide. Thus, the first switching control unit 2351 includes, for example, a counter 2351-1 and a switch 2351-2, and outputs signals for turning ON the switch 2351-2 when the counter 2351-1 coincides with the counted value and the operation mode value, and outputs signals for turning it OFF when they do not coincide. The switch 2351-2 is turned ON or OFF based on the foregoing signals.

The 1st to 432nd delay circuits 2352-1 to 2352-432, the 3rd to 434th multipliers 2353-1 to 2353-432, and the second adder 2354 are, for example, configured the same as the FIR filter. For example, the respective samples of the I signals are sequentially delayed for each sample by the 1st to 432nd delay circuits 2352-1 to 2352-432, and the respective delayed samples are multiplied with the weighting coefficients (Coef[1] to Coef[432]) by the 3rd to 434th multipliers 2353-1 to 2353-432. The respective multiplied samples are sequentially added by the second adder 2354, and output to the first multiplier 236 as the correlation power value of the I signals. The tap count is, for example, the number of sub carriers (432) contained in one segment, and the I signals that were transmitted with one sub carrier are sequentially multiplied as one sample. Accordingly, the first correlator 235-1 outputs, for example, 432 correlation power values for each segment. Note that the weighting coefficients (Coef[1] to Coef[432]) may be, for example, supplied as control signals from the processor 33, or be stored in advance in a memory (not illustrated) of the first correlator 235-1 and read during the processing.

The second correlator 235-2 can also output the correlation power value of the segment that is specified by the operation mode value, for example, as with the first correlator 235-1 illustrated in FIG. 6. However, in the second correlator 235-2, the target is the orthogonal components (Q signals) of the received signals (or baseband signals). For example, the first switching control unit 2351 outputs the Q signals corresponding to the segment that is specified as the operation mode value, and the 1st to 432nd delay circuit 2352-1 to 2352-432, 3rd to 434th multipliers 2353-1 to 2353-432, and the second adder 2354 output the correlation power values corresponding to the Q signals.

Returning to FIG. 5, the first multiplier 236 multiplies the correlation power values of the I signals that were output from the first correlator 235-1. Moreover, the second multiplier 237 multiplies the correlation power values of the Q signals that were output from the first correlator 235-1.

The first adder 238 adds the two multiplied values that were output from the first and second multipliers 236, 237, and outputs the result to the peak detection unit 239.

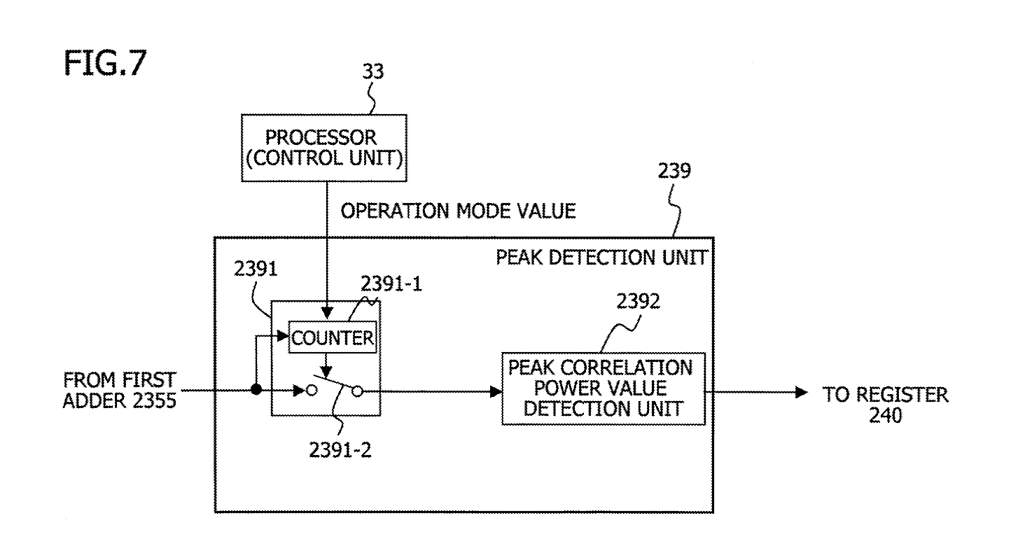

The peak detection unit 239 detects the peak correlation power value based on the correlation power value that is output from the first adder 238. FIG. 7 is a diagram illustrating a configuration example of the peak detection unit 239. The peak detection unit 239 includes a second switching control unit 2391, and a peak correlation power value detection unit 2392.

The second switching control unit 2391 outputs the correlation power value of the segment that is specified by the operation mode value output from the processor 33, and does not output the correlation power value of a segment that is not specified. Thus, the second switching control unit 2391 includes a counter 2391-1 and a switch 2391-2 as with the first switching control unit 2351. For example, the counter 2391-1 counts the number of segments, and turns ON the switch 2391-2 when the segment number corresponding to the counted value and the segment number specified as the operation mode value coincide, and otherwise turns OFF the switch 2391-2.

The peak correlation power value detection unit 2392 detects the peak correlation power value of the segment that is specified by the processor 33 by detecting the correlation power value to become the peak in the correlation power values that were output from the second switching control unit 2391. The peak correlation power value can be obtained, for example, by obtaining the correlation power values above the threshold among the plurality of correlation power values, and setting the one with the greatest correlation power value as the peak correlation power value. The peak correlation power value detection unit 2392 outputs the detected peak correlation power value to the register 240.

Returning to FIG. 5, the register 240 retains, for each segment, the peak correlation power value that is detected by the peak detection unit 239. The processor 33 can acquire the peak correlation power value of the segment that is specified by accessing the register 240.

<Operational Example of Receiving Apparatus 20>

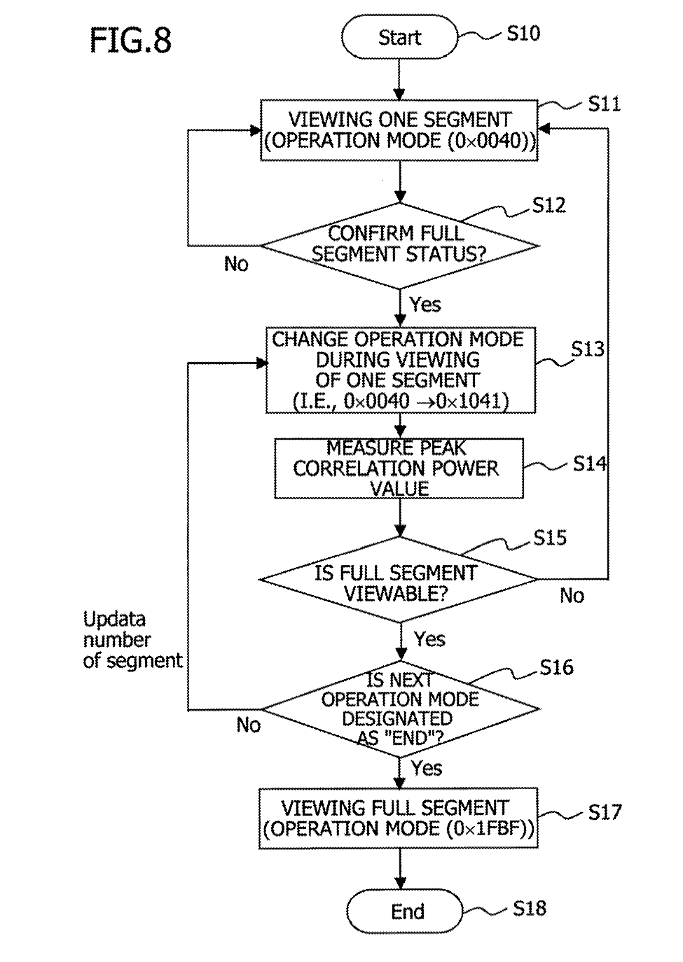

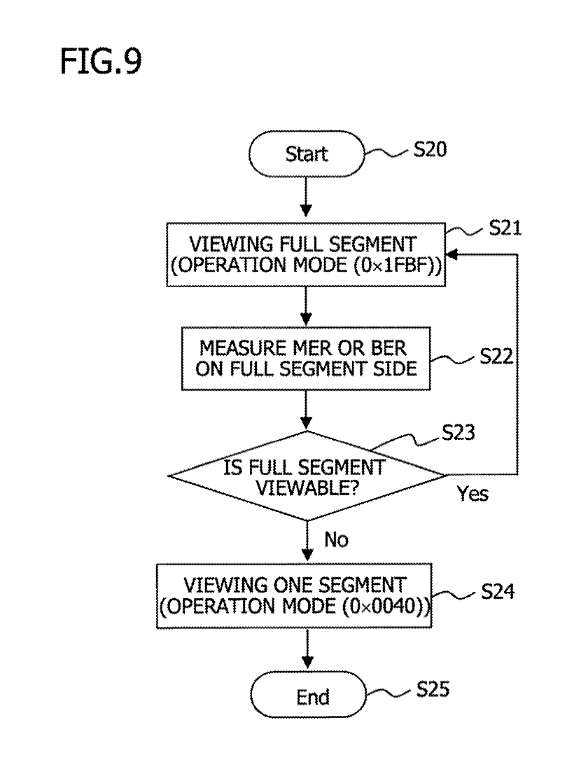

The operational example in the receiving apparatus 20 is now explained. FIG. 8 is a flowchart illustrating the operational example in the case of switching from one segment viewing to full segment viewing in the receiving apparatus 20. Moreover, FIG. 9 is a flowchart illustrating the operational example in the case of switching from full segment viewing to one segment viewing in the receiving apparatus 20.

<Switching from One Segment Viewing to Full Segment Viewing>

The operational example in the case of switching from one segment viewing to full segment viewing is foremost explained. As illustrated in FIG. 8, when the receiving apparatus 20 starts the processing (S10), it enters a one segment viewing status by setting the operation mode value for one segment viewing (S11). The operation mode value is a value representing that, in the operation mode for one segment viewing, the segment with the segment number “0” is the target segment.

For example, the processor 33 sets “0040” as the operation mode value for one segment viewing, and outputs the control signals containing this operation mode value to the first error correction unit 25, the one segment decoding unit 29, and the view layer selection unit 31. The operation mode value in the foregoing case becomes, for example, an operation mode value where layer A is selected, and the “one segment broadcast” is viewed. Consequently, for example, the first error correction unit 25, the one segment decoding unit 29, and the view layer selection unit 31 are activated and perform the various types of processing, and layer A-side video data and audio data are selected, and the user is thereby able engage in one segment viewing. For example, the processor 33 can also output the set operation mode value to the second error correction unit 26 and the full segment decoding unit 30. It is also possible to cause the second error correction unit 26 and the full segment decoding unit 30 to recognize that the operation mode value is an operation mode value for one segment viewing, and refrain from being activated. Note that this operation mode value will be explained in detail later.

Subsequently, the receiving apparatus 20 confirms the full segment status (S12). For example, the processor 33 confirms the full segment status for each given period of time, and makes confirmation based on whether the given period of time as lapsed. Accordingly, for example, when the given period of time is not lapsed (No in S12), the processor 33 waits for the given period of time to lapse, and proceeds to the subsequent processing when the given period of time is lapsed (Yes in S12).

The receiving apparatus 20 changes the operation mode value when the full segment status is confirmed (Yes in S12) (S13). For example, the processor 33 changes the operation mode value. The operation mode value in the foregoing case is, for example, an operation mode value for specifying the segment (hereinafter referred to as the “target segment”) to become the target of measurement of the peak correlation power value.

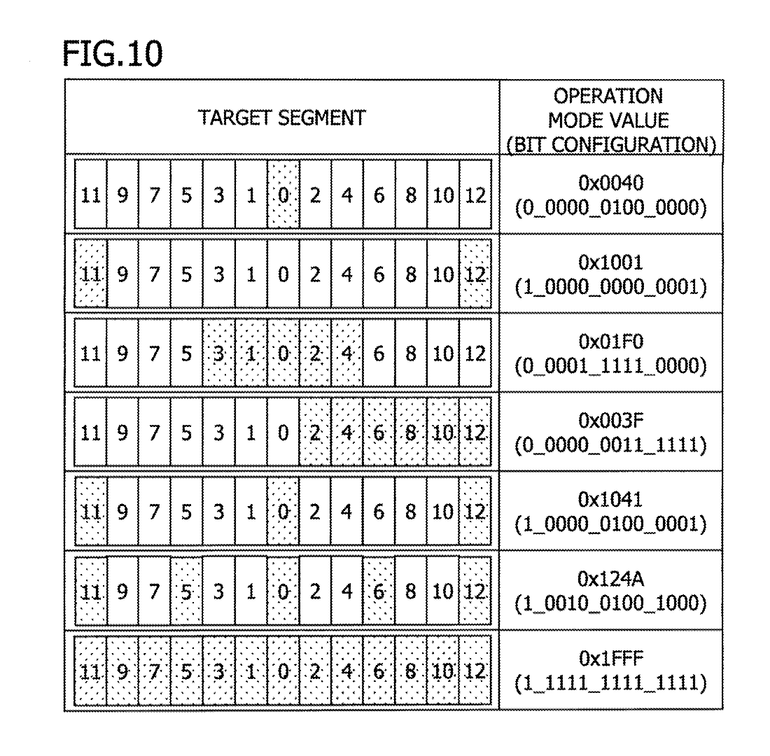

FIG. 10 is a diagram illustrating an example of the correspondence of the target segment and the operation mode value. For example, in order from segment numbers “11” to “0” to “12”, the target segment is represented as “1,” and the non-target segment is represented as “0” as a one-bit configuration, and the numerical value that represents this in a hex formation is used as the operation mode value. For example, when the target segment is “0”, the bit configuration is “0000001000000,” and the operation mode value becomes “0040” as the hex display thereof. When the target segment is “11,” “12”, the operation mode value becomes “1001”. Moreover, when all segments are the target, the operation mode value becomes “1FFF”. Needless to say, this kind of operation mode value is merely an example, and there is no particular limitation so as long as the receiving apparatus 20 can identify the target segment based on the specification of the operation mode value.

Note that, for example, the processor 33 outputs the changed operation mode values as the control signals to the correlation power detection unit 233 of the OFDM demodulation unit 23. The processor 33 can also output, for example, the changed operation mode values to a processing block other than the correlation power detection unit 233. In the foregoing case, for example, it is also possible to cause the first error correction unit 25 and the one segment decoding unit 29 to recognize that the operation mode value is not changed to a value of one segment viewing or full segment viewing, and refrain from performing any internal processing.

Returning to FIG. 8, the receiving apparatus 20 thereafter measures the peak correlation power value of the target segment (S14). For example, as explained above, the processor 33 measures the peak correlation power value of the target segment by outputting the control signals containing the operation mode values to the first and second correlators 235-1, 235-2, and the peak detection unit 239. For example, as described above, based on the ON or OFF of the first switching control unit 2351 in the first and second correlators 235-1, 235-2, the received signals of the target segment are input and the correlation value is measured. Moreover, the peak detection unit 239 measures the peak correlation power value of the target segment based on the input of the correlation value of the target segment according to the ON or OFF of the second switching control unit 2391. The peak detection unit 239 stores the measured peak correlation power value in the register 240.

Subsequently, the receiving apparatus 20 determines whether the full segment is viewable (S15). For example, the processor 33 reads the peak correlation power value stored in the register 240, and compares it with a threshold that enables full segment viewing in order to perform the determination. For example, the processor 33 determines that the full segment is viewable when the read peak correlation power value is not less than the threshold (Yes in S15), and determines that the full segment is not viewable when the peak correlation power value is smaller than the threshold (No in S15).

The receiving apparatus 20 returns to the processing of S11 when the full segment is not viewable (No in S15), and repeats the foregoing processing. In the foregoing case, for example, since the processor 33 will not change from the one segment viewing status to the full segment viewing status, it does not need to output the operation mode value for one segment. Specifically, the receiving apparatus 200 changed the operation mode value (S13), for example, but it is the specification of the operation mode value for measuring the peak correlation power value of the target segment, and it is not the specification of the operation mode value for changing from one segment viewing to full segment viewing. Thus, for example, the processor 33 may re-specify and output the operation mode value representing the one segment viewing, or maintain its status concerning the operation mode value without conducting such specification.

Meanwhile, when the full segment is viewable (Yes in S15), the receiving apparatus 20 determines whether “End” is specified as the operation mode value (S16). For example, if there is no target segment to be specified after the target segment that is specified in S13 by the processor 33, the operation mode value (for instance, “FFFF”) representing “End” is output to the correlation power detection unit 233. The correlation power detection unit 233, for example, stops its operation or activation based on the input of the foregoing operation mode value.

Note that whether the processor 33 is to output the operation mode value representing “End”, for example, can also be decided as follows. Specifically, the processor 33 preliminarily decides a segment pattern on how to specify the target segment for which the peak correlation power value is to be measured. The processor 33 outputs the operation mode value of “End” when the peak correlation power value of the last segment in the segment pattern is a value that is sufficient for enabling full segment viewing (Yes in S15). An example of the segment pattern will be described later.

When “End” is specified as the next operation mode value (Yes in S16), the receiving apparatus 20 sets the operation mode value for full segment viewing, and changes to a full segment viewing status (S17). For example, the processor 33 outputs the operation mode value (for instance, “1FFF”) specifying the segment numbers “1” to “12” to the FFT unit 232 of the OFDM demodulation unit 23, the second error correction unit 26, the full segment decoding unit 30, and the view layer selection unit 31. The operation mode value in the foregoing case is, for example, and operation mode value in which layer B is selected and the “full segment broadcast” is viewed. Consequently, the FFT unit 232 expands, for example, the target of FFT processing from the received signals with the segment number “0” to the received signals with the segment numbers “1” to “12”. Moreover, the second error correction unit 26 and the full segment decoding unit 30 are activated based on the input of the operation mode value for full segment viewing, and, for example, performs decoding processing and the like to the received signals with the segment numbers “1” to “12”. Meanwhile, the processor 33 can also output the operation mode value for full segment viewing to the first error correction unit 25 and the full segment decoding unit 30, and, in the foregoing case, the first error correction unit 25 and the full segment decoding unit 30 stop their activation based on the input of the operation mode value. Consequently, for example, the receiving apparatus 20 enters the “layer B only” status, and the user can thereby view the full segment broadcast.

The receiving apparatus 20 thereafter ends the sequential processing (S18).

Meanwhile, when “End” is not specified as the next operation mode value (No in S16), the receiving apparatus 20 updates the target segment by changing the operation mode value that specified the target segment (S13). The update of the target segment will be in accordance with, for example, the segment pattern. The segment pattern can also be ended with the single confirmation of the full segment viewing based on one segment pattern as described above (the operation mode value is changed first (S13), and, if full segment is viewable (S15), “End” is specified). Moreover, it is also possible to confirm the full segment viewing a plurality of times with a plurality of segment patterns (No in S16, and the operation mode value is updated) (the operation mode value is changed first (S13), and, if full segment is viewable (S15), “End” is specified). Here, as examples of the segment pattern, two patterns will be separately explained; namely, a pattern that ends after one confirmation, and a pattern that performs the confirmation a plurality of times.

<Example of Segment Pattern>

An example of the segment pattern that ends after one confirmation is foremost explained. Here, as described above, the processor 33 outputs the operation mode value specifying the segment pattern to the correlation power detection unit 233, and causes it to measure the peak correlation power value (for instance, S14 of FIG. 8). Subsequently, the processor 33 outputs the operation mode value of “End” when the measurement result even once satisfies (Yes in S15) the full segment viewing conditions (for instance, S15).

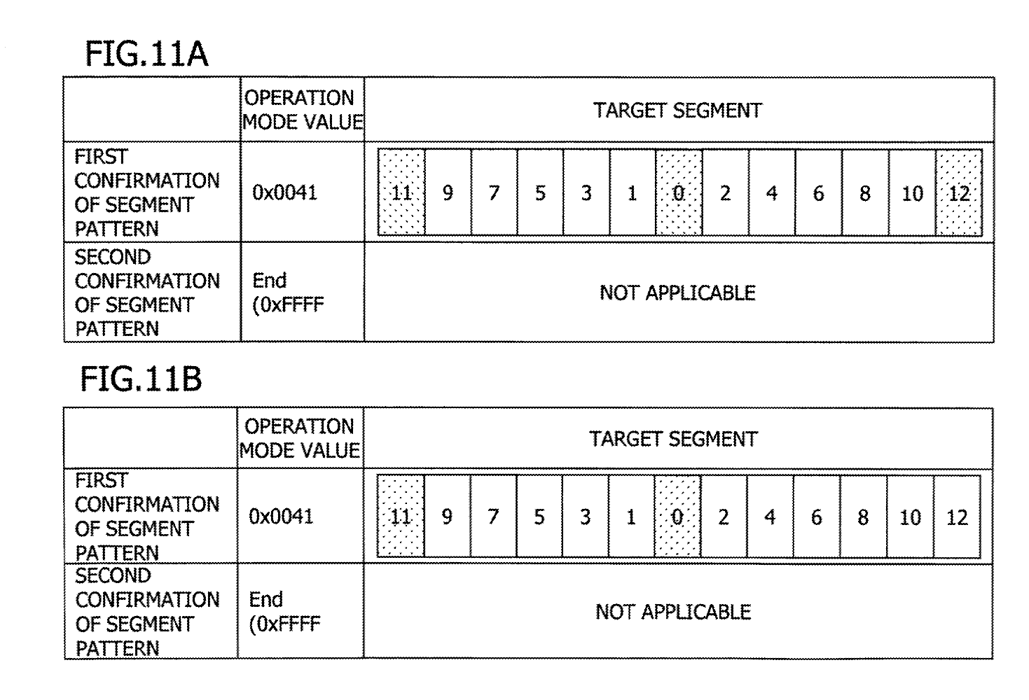

FIG. 11A and FIG. 11B are diagrams illustrating the segment patterns. As illustrated in FIG. 11A, for example, the segment pattern can be formed with the segment numbers “0,” “11,” “12” as the target segments. In the foregoing case, the processor 33 outputs the operation mode value of “End” when, for example, the peak correlation power values of all three segments are not less than the threshold (Yes in S15) that enables full segment viewing (Yes in S16). Otherwise, for example, the processor 33 can also add the peak correlation power values of the three segments, and determine that the full segment viewing conditions are satisfied (Yes in S15) when the added value is not less than the threshold that enables full segment viewing.

In the example of FIG. 11A, among the frequency bands for terrestrial digital broadcast, the segment with the highest frequency band and the segment with the lowest frequency band are specified as the segment pattern. These two segments, in comparison to the other segments, are most easily affected by signals of a frequency band other than the frequency band for terrestrial digital broadcast. Accordingly, if the peak correlation power value of the two segments with the greatest external pressure is sufficient for enabling full segment viewing, the receiving apparatus 20 can determine that the full segment is viewable without having to measure the peak correlation power value of the other segments.

Moreover, as illustrated in FIG. 11A, the segment number “0” may be included in the segment pattern. Since the segment number “0” is a segment for one segment broadcast, for example, the processor 33 can confirm whether the one segment is viewable based on the peak correlation power value of that segment.

In the example illustrated in FIG. 11B, the segment numbers “0,” “11” are used as the segment pattern. Accordingly, as the segment pattern, the target segments other than the segment number “0” do not necessarily have to be multiple, and it may be a single segment. In the foregoing case, the target segment can be segment numbers “0,” “12”.

In addition, as illustrated in FIG. 10, for example, a segment pattern of segment numbers “11,” “12” which does not contain the segment number “0” can also be used. For example, the segment number “11” can be used as the target segment, or the segment number “12” can be used as the target segment.

Moreover, as illustrated in FIG. 10, among all frequency bands for terrestrial digital broadcast, a segment pattern that uses the segments included in the intermediate frequency band such as segment numbers “0” to “4” as the target segment can also be used. Otherwise, a segment pattern that uses even numbered segments or odd numbered segments as the target segment can also be used. For example, even numbered segments are the segments belonging to the high frequency band among all frequency bands for terrestrial digital broadcast, and odd numbered segments are the segments belonging to the low frequency band among all frequency bands for terrestrial digital broadcast.

In addition, there is a segment pattern that uses the segment numbers “0,” “5,” “6,” “11,” “12” as the target segment. The segment pattern in the foregoing case, for example, uses segments that are arranged for every two segments among all frequency bands for terrestrial digital broadcast as the target segment. For example, as the segment pattern, a pattern in which segments are arranged for each segment such as the segment numbers “0,” “3,” “4,” “7,” “8,” “11,” “12” are used as the target segment can also be used.

In addition, it is also possible to use a segment pattern in which the segments of segment numbers “1” to “10” are used as the target segment, or a segment pattern in which all segments from segment numbers “0” to “12” are used as the target segment.

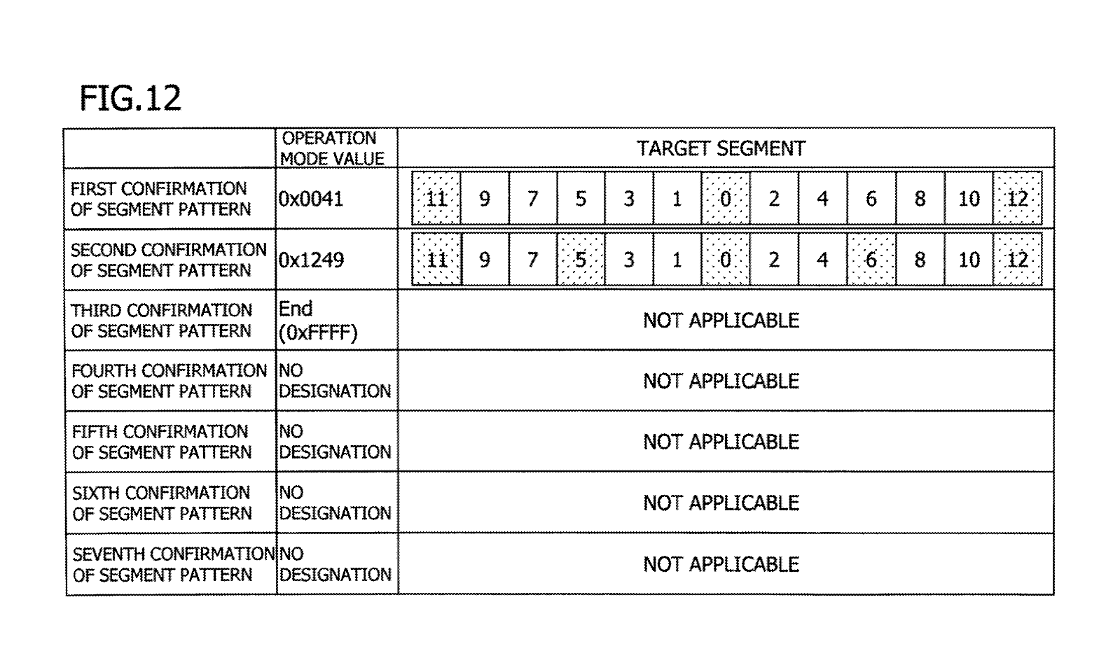

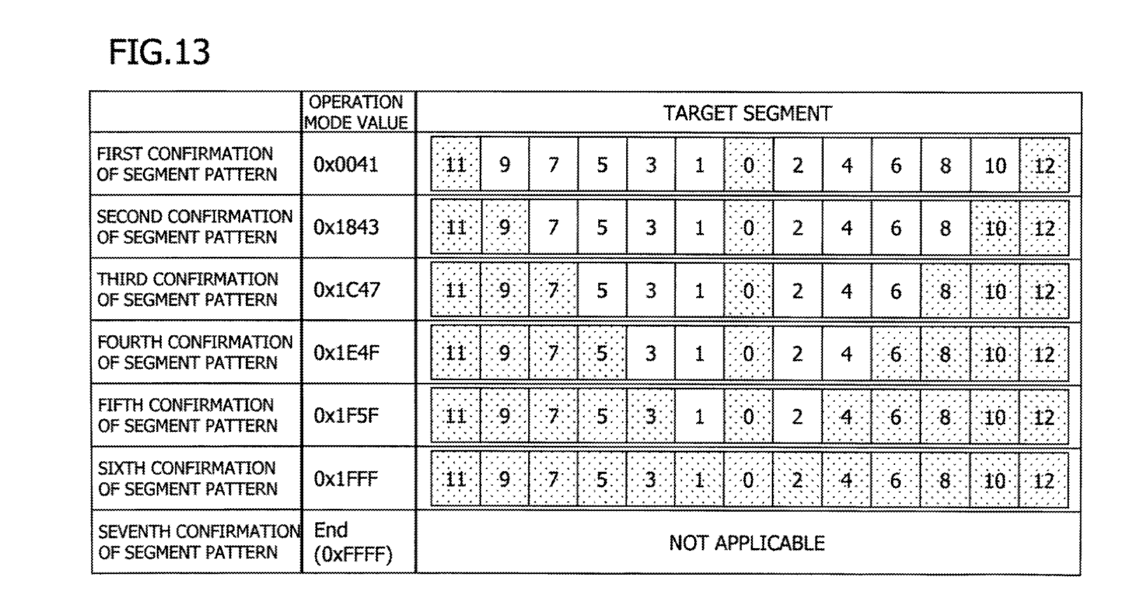

Examples of segment patterns in cases where the confirmation is performed a plurality of times are now explained. Here, as described above, explained is a case where the confirmation of the full segment viewing is performed a plurality of times such as using a certain segment pattern initially, and using another segment pattern thereafter. FIG. 12 and FIG. 13 respectively illustrate examples of this kind of segment pattern, and FIG. 12 illustrates an example where confirmation is performed using two segment patterns, and FIG. 13 illustrates an example where confirmation is performed using six segment patterns, respectively.

In the example of FIG. 12, the first segment pattern uses segment numbers “0,” “11,” “12”, and the second segment pattern is an example where segment numbers “5,” “6” are additionally added. For example, the processor 33 initially outputs the operation mode value “1041” to the correlation power detection unit 233, and causes it to measure the peak correlation power value of the respective segment numbers “0,” “11,” “12” (S14). When all measurement results are not less than the threshold that enables full segment viewing (when the full segment viewing conditions are satisfied) (Yes in S15), the processor 33, for example, outputs the operation mode value “1249” to the correlation power detection unit 233 (No in S16, S13). The correlation power detection unit 233 measures the peak correlation power value of the respective segments of the segment numbers “0,” “5,” “6,” “11,” “12”. The processor 33 outputs the operation mode value representing “End” when, for example, all measurement results satisfy the full segment viewing conditions, and determines that the full segment is viewable (Yes in S16, S17). For example, as illustrated in FIG. 12, in addition to the segment pattern in which the target segments increase by “2” when the number of confirmations is increased by one, the target segments may be increased by one or more such as by being increased “1” at a time increased “3” at a time. When the target segments are increased by one or more, which segment may be added to the target segment may be an arbitrary segment.

In the example of FIG. 13, the first segment pattern uses segment numbers “0,” “11,” “12”, and the second segment pattern is a pattern in which the segment numbers “9,” “10” were added to the first segment pattern. The third segment pattern is a pattern in which the segment numbers “7,” “8” were added to the second segment pattern. Subsequently, the pattern increases the target segments so as to add the target segments from a low frequency band segment or a high frequency and segment toward the segment of segment number “0”. In the final sixth segment pattern, all segments are targets, and the confirmation of the full segment viewing conditions is performed to all segments.

Upon comparing the example of FIG. 12 and the example of FIG. 13, both cases illustrate a segment pattern in which the target segments are sequentially increased, but the example of FIG. 13 is a pattern that ends when all segments are confirmed, and the example of FIG. 12 is a pattern that ends midway without confirming all segments. Since all segments are confirmed in the example of FIG. 13, the probability that the user can view the full segment broadcast is higher than the example of FIG. 12 that does not confirm all segments. Meanwhile, since the example of FIG. 12 is ended after two confirmations, the processing speed from start to end is faster in comparison to the case where the processing does not end until all segments are confirmed, and the time till full segment viewing is shorter. For example, if the user prefers stable full segment viewing, the example of FIG. 13 can be used, and if the user prefers to watch the full segment viewing quickly even if there is some noise, the example of FIG. 12 can be used. Moreover, in either case, in the case of a segment pattern where the target segments are increased, the confirmation (S15) of the full segment viewing conditions can be performed by confirming fewer segments than the case of confirming all segments.

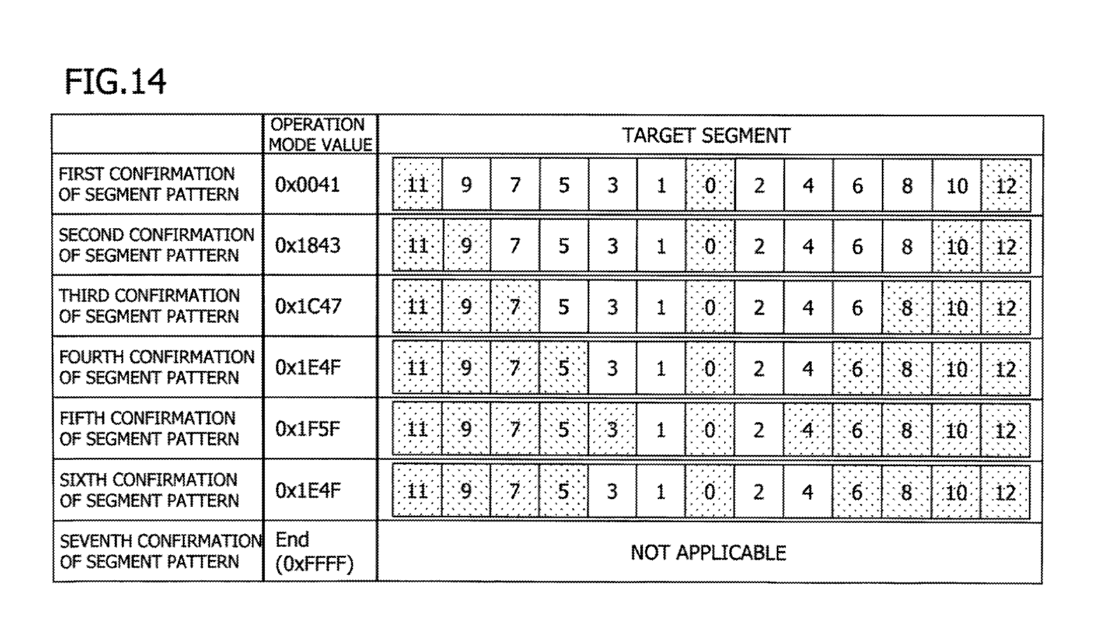

FIG. 14 is a diagram also illustrating an example of the segment pattern in the case where the confirmation is performed a plurality of times. The examples of FIG. 12 and FIG. 13 illustrated examples of patterns where the target segments of the segment pattern are increased. The example of FIG. 14 is an example of a segment pattern in which the target segments are decreased. For example, in the fifth segment pattern, the peak correlation power value of all segments excluding the segment numbers “1,” “2” is measured. Here, for example, among the target segments, there may be cases where the peak correlation power value of a segment cannot be measured, and the full segment viewing conditions cannot be satisfied numerous times (for instance, No in S15). In anticipation of the foregoing situation, as the segment pattern, the sixth segment pattern can be such that the peak correlation power value is measured for fewer segments in comparison to the fifth target segments. Otherwise, for example, the processor 33 can also set a threshold concerning the number of times that the full segment viewing conditions are not satisfied, and, if the number of times that the full segment viewing conditions are not satisfied exceeds the foregoing threshold, change the segment pattern so as to reduce the target segments.

Note that, even in the segment pattern illustrated in FIG. 14, for example, as the third segment pattern, the segment pattern (segment numbers “0,” “11,” “12” are the target segments) that is the same as the first pattern can be used. Otherwise, the fourth segment pattern can be the same pattern as the third segment pattern.

As described above, as the segment pattern, in addition to the patterns where the target segments are increased pursuant to the increase in the number of confirmations, it may also include a pattern where the number of target segments are decreased. Moreover, the segment pattern may be a combination of a pattern where the number of target segments are increased and a pattern where they are decreased. In addition, the number of target segments may be the same even if the number of confirmations is increased, and it is also possible to use a segment pattern where the target segments themselves are changed without any change in the number of target segments; for instance, the first time it is segment numbers “0,” “11,” “12,” and the second time it is segment numbers “0,” “9,” “10”.

Accordingly, when the receiving apparatus 20 confirms the full segment viewing (or full segment viewing conditions (for instance, S15 of FIG. 8)) in the one segment viewing status, for example, it does not use all segments or all segments for full segment as the target segments. The receiving apparatus 20 uses as the target segments, for example, segments that do not target all segments for full segment, whether one or more, among all segments or all segments used for full segment broadcast. Thus, the receiving apparatus 20 can reduce the number of segments to be measured and thereby reduce its power consumption in comparison to the case of using all segments or all segments for full segment as the target segments.

Moreover, in comparison to the case of operating both the first and second error correction units 25, 26 and measuring the MER or BER, the receiving apparatus 20 can reduce its power consumption since it is may not to operate the first and second error correction units 25, 26.

In addition, since the receiving apparatus 200 determines the full segment viewing conditions of full segment viewing when the one segment broadcast is being viewed, it can continuously perform view switching without any interruption in the switching one segment viewing to full segment viewing.

Moreover, the receiving apparatus 20 will not activate the second error correction unit 26, for example, upon determining that the full segment viewing conditions are not satisfied because the radio wave condition is not favorable (for instance, No in S15 of FIG. 8). Accordingly, since the receiving apparatus 20 will not change to the “both layers A and B” status upon determining that the radio wave condition is not favorable, it can reduce its power consumption regardless of the radio wave condition in comparison to the case of changing to the “both layers A and B” status numerous time.

In addition, the receiving apparatus 20 detects the target peak correlation power values in the full segment viewing conditions in the correlation power detection unit 233 that is positioned before the FFT unit 232. Accordingly, since the receiving apparatus 20 will not determine the full segment viewing conditions upon activating the FFT unit 232, it can reduce its power consumption in comparison to the case of performing the determination upon activating the FFT unit 232.

<Switching from Full Segment Viewing to One Segment Viewing>

An example of the switching operation from full segment viewing to one segment viewing in the receiving apparatus 20 is now explained. FIG. 9 is a flowchart illustrating an example of the switching operation from full segment viewing to one segment viewing.

When the receiving apparatus 20 starts the processing (S20), it sets the operation mode value for full segment viewing (for instance, “1FBF”) (S21). The operation mode value in the foregoing case is an operation mode value in which, for example, layer B is selected and the “full segment broadcast” is viewed. For example, the processor 33 outputs the foregoing operation mode value to the FFT unit 232 of the OFDM demodulation unit 23, the second error correction unit 26, the full segment decoding unit 30, and the view layer selection unit 31. These processing units are activated based on the input of the foregoing operation mode value, and FFT processing to the layer B-side received signals and other processing is performed. Consequently, the receiving apparatus 20 enters, for example, the “layer B only” status, and the user can thereby view the full segment broadcast.

Subsequently, the receiving apparatus 20 measures the full segment-side (layer B-side) MER or BER (S22). For example, the second error correction unit 26 measures MER in the demodulation processing to the received signals containing complex components (I signals and Q signals). Otherwise, for example, the second error correction unit 26 measures BER in the decoding processing to the demodulated received signals.

Subsequently, the receiving apparatus 20 determines whether the measured MER or BER satisfies the full segment viewing conditions (S23). For example, the processor 33 acquires the MER or BER measured by the second error correction unit 26 from the second error correction unit 26, and determines whether it is greater than the threshold that enables full segment viewing.

When the measured MER or BER satisfies the full segment viewing conditions (Yes in S23), the receiving apparatus 20 maintains the full segment viewing status (S21). For example, when the MER or BER is greater than the threshold that enables full segment viewing, the processor 33 outputs the operation mode value for full segment (for instance, hex display of “1FBF”) to the OFDM demodulation unit 23. In the foregoing case, the processor 33 can also be configured not to output the operation mode value for full segment since the switching from full segment viewing to one segment viewing is not performed.

Meanwhile, when the measured MER or BER does not satisfy the full segment viewing conditions (No in S23), the receiving apparatus 20 determines that the full segment is not viewable, and performs the switching from full segment viewing to one segment viewing (S24). For example, the processor 33 outputs the operation mode value for one segment (for instance, “0040”) when the measured MER or BER is smaller than the threshold that enables full segment viewing. The operation mode value in the foregoing case is an operation mode value in which layer A is selected, and the “one segment broadcast” is viewed. The output specification will be, for example, the OFDM demodulation unit 23, the first and second error correction units 25, 26, the one segment decoding unit 29, the full segment decoding unit 30, and the view layer selection unit 31. The FFT unit 232 of the OFDM demodulation unit 23 changes the processing target of FFT from the full segment to the received signals that have been received with the segments for one segment based on the input of the operation mode value for one segment. For example, the layer B-side second error correction unit 26 and full segment decoding unit 30 stop their activation based on the input of the operation mode value for one segment, and the layer A-side first error correction unit 25 and one segment decoding unit 29 are activated based on the input of the operation mode value for one segment. Consequently, for example, the receiving apparatus 20 enter the “layer A only” status, and the user can thereby view the one segment broadcast.

The receiving apparatus 20 thereafter ends the sequential processing (S25).

### OTHER EXAMPLES

In the second embodiment, the connection destination of the processor 33 is explained as the OFDM demodulation unit 23, the first and second error correction units 25, 26, the one segment decoding unit 29, the full segment decoding unit 30, and the view layer selection unit 31 (for instance, FIG. 3). For example, the processor 33 can be connected to one or all of the following; namely, the RF unit 22, the layer separation unit 24, the layer connection unit 27, the MPEG-TS separation unit 28, the view layer selection unit 31, and the AV synchronization unit 32. Based on the control signals from the processor 33, for example, the operation of the respective components can be controlled; for instance, the operation of the RF unit 22 performing frequency conversion or the layer separation unit 24 separating the respective signals of layer A and layer B.

Moreover, in the second embodiment, explained is a case where the processor 33 outputs the operation mode value representing the target segment to the first and second correlators 235-1, 235-2 and the peak detection unit 239 (for instance, FIG. 5). For example, the configuration may be such that the processor 33 does not output the operation mode value to the peak detection unit 239. If the target segment is selected in the first and second correlators 235-1, 235-2, the configuration may be such that the target segment is not selected in the peak detection unit 239. In the foregoing case, the peak detection unit 239 does not need to include the second switching control unit 2391.

In addition, in the second embodiment, the receiving apparatus 20 detected the peak correlation power value and determined whether the full segment is viewable based thereon (for instance, S14 and S15 of FIG. 8). In addition to the peak correlation power value, for example, the full segment viewing conditions can also be determined based on the ratio of peak power value and average power value (Peak to Average Power Ratio). In the foregoing case also, the receiving apparatus 20 can determine that the full segment is viewable when the PAPR is not less than the threshold that enables full segment viewing, and otherwise determine that the full segment is not viewable (for instance, S14 and S15 of FIG. 8). When the full segment viewing conditions are determined (for instance, S15), for example, desirably, determination is made based on an index such as the power value of the received signals prior to the FFT processing being performed by the FFT unit 232.

In addition, the receiving apparatus 20 explained in the first and second embodiments can also be implemented in another configuration example.

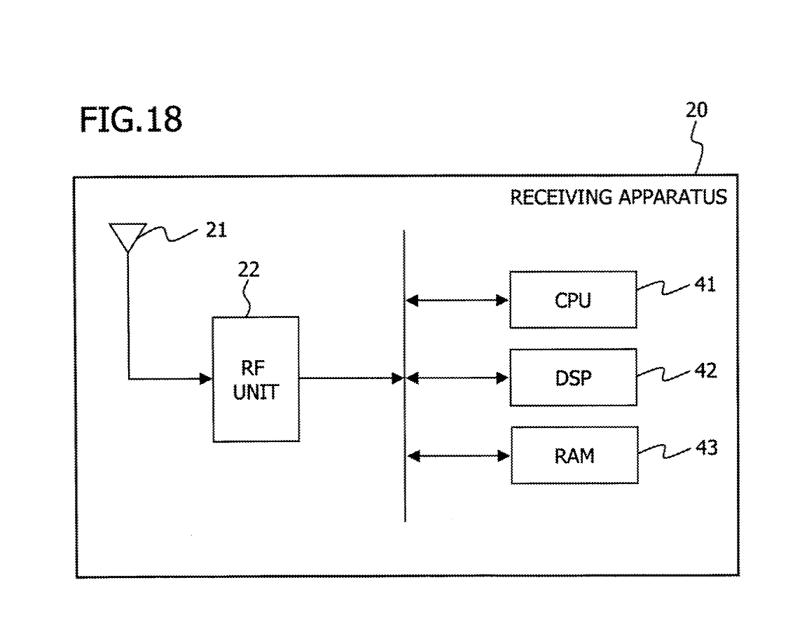

FIG. 18 is a diagram illustrating another configuration example of the receiving apparatus 20. The receiving apparatus 20 additionally includes a CPU (Central Processing Unit) 41, a DSP (Digital Signal Processor) 42, and a RAM (Random Access Memory) 43. For example, the processor 33 in the second embodiment corresponds to the CPU 41. For example, the respective functions from the OFDM demodulation unit 23 to the AV synchronization unit 32 in the second embodiment are realized based on the coordinated operation of the CPU 41, the DSP 42, and the RAM 43. Moreover, the control unit 251 in first embodiment corresponds to the CPU 41. The receiving unit 251 in first embodiment corresponds to the antenna 21 and the RF unit 22, and can be realized based on the coordinated operation of the CPU 41, the DSP 42, and the RAM 43.

The foregoing explanation can be summarized as per the following Supplementary Notes.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention has been described in detail, it should be understood that the various changes, substitutions, and alterations could be made hereto without departing from the spirit and scope of the invention.

What is claimed is:

1. A receiving apparatus for being viewable of a first broadcast based on a first received signal received using a first frequency band as any one frequency band of a plurality of frequency bands, or being viewable of a second broadcast based on a second received signal received using a second frequency band as all frequency bands other than the first frequency band of the plurality of frequency bands, the receiving apparatus comprising:
a receiving unit which receives a third received signal by using a third frequency band as any one frequency band of a plurality of frequency bands included in the second frequency band when the first broadcast is being viewed; and
a control unit which determines whether the second broadcast is viewable or nor based on the third received signal, and switches from viewing of the first broadcast to viewing of the second broadcast when it is determined that the second broadcast is viewable.

2. The receiving apparatus according to claim 1, wherein
the third frequency band is a frequency band with a highest frequency or a frequency band with a lowest frequency of the plurality of frequency bands included in the second frequency band.

3. The receiving apparatus according to claim 1, wherein
the receiving unit receives the third received signal, and a fourth received signal by using a fourth frequency band as any one frequency band other than the third frequency band of the plurality of frequency bands included in the second frequency band, and
the control unit determines whether the second broadcast is viewable or not based on the third and fourth received signals.

4. The receiving apparatus according to claim 3, wherein
the third frequency band is a frequency band with a highest frequency of the plurality of frequency bands included in the second frequency band, and the fourth frequency band is a frequency band with a lowest frequency of the plurality of frequency bands included in the second frequency band.

5. The receiving apparatus according to claim 3, wherein
the receiving unit receives the third and fourth received signals, and a fifth received signal by using a fifth frequency band as one or more frequency bands other than the third and fourth frequency bands of the plurality of frequency bands included in the second frequency band, and
the control unit determines whether the second broadcast is viewable or not based on the third, fourth, and fifth received signals.

6. The receiving apparatus according to claim 5, wherein
the third, fourth, and fifth frequency bands include a high frequency band of higher frequency than an other frequency band other than the third, fourth, and fifth frequency bands of the plurality of frequency bands included in the second frequency band, or include a low frequency band of lower frequency than the other frequency band.

7. The receiving apparatus according to claim 5, wherein
the third, fourth, and fifth frequency bands are frequency bands disposed every one or two frequency bands of the plurality of frequency bands included in the second frequency band.

8. The receiving apparatus according to claim 1, wherein
the receiving unit receives the third received signal, and a sixth received signal by using a sixth frequency band as any one frequency band other than the third frequency band of the plurality of frequency bands included in the second frequency band when the control unit determines that the second broadcast is viewable, and
the control unit determines whether the second broadcast is viewable or not based on the third and sixth received signals.

9. The receiving apparatus according to claim 8, wherein
the receiving unit receives the third received signal by using the third frequency band when the control unit determines that the second broadcast is not viewable based on the third and sixth received signals, and
the control unit determines whether the second broadcast is viewable or not based on the third received signal.

10. The receiving apparatus according to claim 8, wherein
the receiving unit receives an other received signal by using all frequency bands included in the second frequency band, and
the control unit determines whether the second broadcast is viewable or not based on the other received signal.

11. The receiving apparatus according to claim 3, wherein
the receiving unit receives the third and fourth received signals, and seventh and eighth received signals by using seventh and eighth frequency bands respectively indicating any one frequency band other than the second and fourth frequency bands of the plurality of frequency bands included in the second frequency band, when the control unit determines that the second broadcast is viewable based on the third and fourth received signals, and
the control unit determines whether the second broadcast is viewable or not based on the third, fourth, seventh, and eighth received signals.

12. The receiving apparatus according to claim 11, wherein
the receiving unit receives the third and fourth received signals by using the third and fourth frequency bands respectively, when the control unit determines that the second broadcast is not viewable based on the third, fourth, seventh, and eighth received signals, and
the control unit determines whether the second broadcast is viewable or not based on the third and fourth received signals.

13. The receiving apparatus according to claim 12, wherein
the seventh and eighth frequency bands are frequency bands that are more on an intermediate frequency band side in the second frequency band than the third and fourth frequency bands.

14. The receiving apparatus according to claim 12, wherein
the receiving unit receives an other received signal by using all frequency bands included in the second frequency band, and
the control unit determines whether the second broadcast is viewable or not based on the other received signal.

15. The receiving apparatus according to claim 1, wherein
the control unit outputs a control signal specifying the third frequency band to the receiving unit, and the receiving unit receives the third received signal by using the third frequency band according to the control signal.

16. The receiving apparatus according to claim 1, wherein
the receiving unit includes a correlation power detection unit which detects a peak correlation power value of the third received signal, and
the control unit determines whether the second broadcast is viewable or not based on the peak correlation power value.

17. The receiving apparatus according to claim 16, wherein
the correlation power detection unit detects the peak correlation power value before the first or second received signal is converted from a time domain signal into a frequency domain signal.

18. The receiving apparatus according to claim 1, wherein
the control unit continues the viewing of the first broadcast when the control unit determines that the second broadcast is not viewable.

19. A receiving method in a receiving apparatus for being viewable of a first broadcast based on a first received signal received using a first frequency band as any one frequency band of a plurality of frequency bands, or being viewable of a second broadcast based on a second received signal received using a second frequency band as all frequency bands other than the first frequency band of the plurality of frequency bands, the method comprising:
receiving a third received signal by using a third frequency band as any one frequency band of a plurality of frequency bands included in the second frequency band when the first broadcast is being viewed; and
determining whether the second broadcast is viewable or not based on the third received signal, and switching from viewing of the first broadcast to viewing of the second broadcast when it is determined that the second broadcast is viewable.
